(19) United States
(12) Patent Application Publication
(10) Pub. No.: US 2010/0003002 A1
(43) Pub. Date: Jan. 7, 2010

(54) Robust connector enforcement

(75) Inventors: Marc R. Bernard, Miramar, FL (US); Douglas A. Atkinson, Ashburn, VA (US); Joseph C. Roesch, Herndon, VA (US); Adrian S. Chan, New Market, MD (US); David H. Liu, Herndon, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/217,338

(22) Filed: Jul. 3, 2008

(51) Int. Cl. G02B 6/44

(52) U.S. Cl. 385/139

(57) ABSTRACT

The need for fiber optic connectors is increasing as the use of fiber optic transmission members is being incorporated in data and other transmission systems. Typically, strain relief provides extra support at the junction of a cable and connector interface. However, there is a need to provide strain relief for the connector portion itself. An example cover includes a housing member defining an aperture spanning transversely from a first end to a second end and engages a connector therewithin. The cover further includes at least two prongs protruding from the first end in a direction opposite to the second end in an axial direction relative to the aperture. The prongs may be inserted into a panel defining at least two openings to receive the prongs. The prongs in combination with the housing member provide strain relief to the connector in an angular direction relative to the at least two prongs.

### RELATED APPLICATION

This application is related to U.S. patent application Ser. No. 12/154,227 entitled, “Network Terminal Cover,” filed May 21, 2008. The entire teachings of the above application are incorporated herein by reference.

### BACKGROUND OF THE INVENTION

Fiber optic connectors are increasing as the use of fiber optic transmission members is being incorporated in data and other transmission systems. Typically, fiber optic connectors have four basic components: a ferrule, connector body, cable, and coupling device. The ferrule is a fiber alignment mechanism with a bore generally at the center having a diameter slightly larger than the fiber cladding. The connector body generally holds the ferrule such that the ferrule extends beyond the length of the connector body to slip into a coupling device. The connector body is generally attached to strengthening members or cable jackets via crimping or bonding. A strain relief boot is typically added at the cable and connector interface to provide extra protection for the cable only.

Despite efforts by the strain relief boot to provide extra protection at the cable and connector interface, many potential sources for damage still exist. One known source is the damage to the connector itself during the placement of the fiber optic connector to a faceplate. For example, care is taken not to violate the minimum bend radius of the cable and not to create tension on the connector itself by pulling on the fiber.

### SUMMARY OF THE INVENTION

A method and corresponding connector cover of providing strain relief to the connector in accordance with an embodiment of the present invention is provided. An example embodiment of the connector cover includes a housing member defining an aperture spanning transversely from a first end to a second end. The aperture may engage a connector therewithin. The cover further includes at least two prongs protruding from the first end in a direction opposite to the second end in an axial direction relative to the aperture; the at least two prongs may be inserted into a panel defining at least two openings to receive the at least two prongs. The at least two prongs in combination with the housing member provide strain relief to the connector in an angular direction relative to the at least two prongs.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is an example mechanical diagram illustrating potential strain that may be imparted to a connector during installation of the connector to a faceplate of a chassis;

FIG. 1B is a perspective view of an example connector cover in accordance with an embodiment of the present invention;

FIG. 1C is a three-dimensional view of an example connector cover with a fiber optic connector engaging a faceplate in accordance with an embodiment of the present invention;

FIG. 1D is another three-dimensional view of an example connector cover with a fiber optic connector engaging a faceplate in accordance with an embodiment of the present invention;

FIG. 2A is a three-dimensional view of another example connector cover with a fiber optic connector engaging a faceplate in accordance with an embodiment of the present invention;

FIG. 2B is a plan view of another example connector cover illustrating an operation thereof in accordance with an embodiment of the present invention;

FIG. 2C is a perspective view of an example connector cover in accordance with an embodiment of the present invention;

FIG. 3 is an example flow diagram performed in accordance with an embodiment of the present invention; and

FIG. 4 is another example flow diagram performed in accordance with an embodiment of the present invention.

### DETAILED DESCRIPTION OF THE INVENTION

A description of example embodiments of the invention follows.

Typically, strain relief provides protection for a cable. Strain relieves typically include a series of ridges at a point where cabling meets a connector or plug to allow flexibility in the cable without putting stress on the cable at that point. In some applications, providing extra support for the connector itself may be useful.

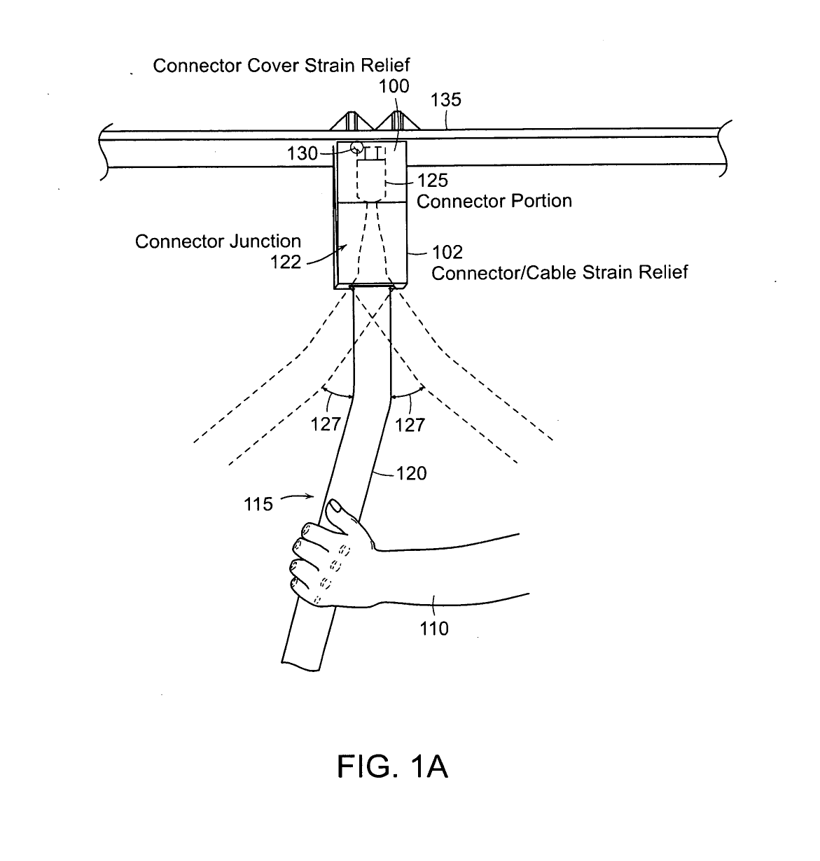

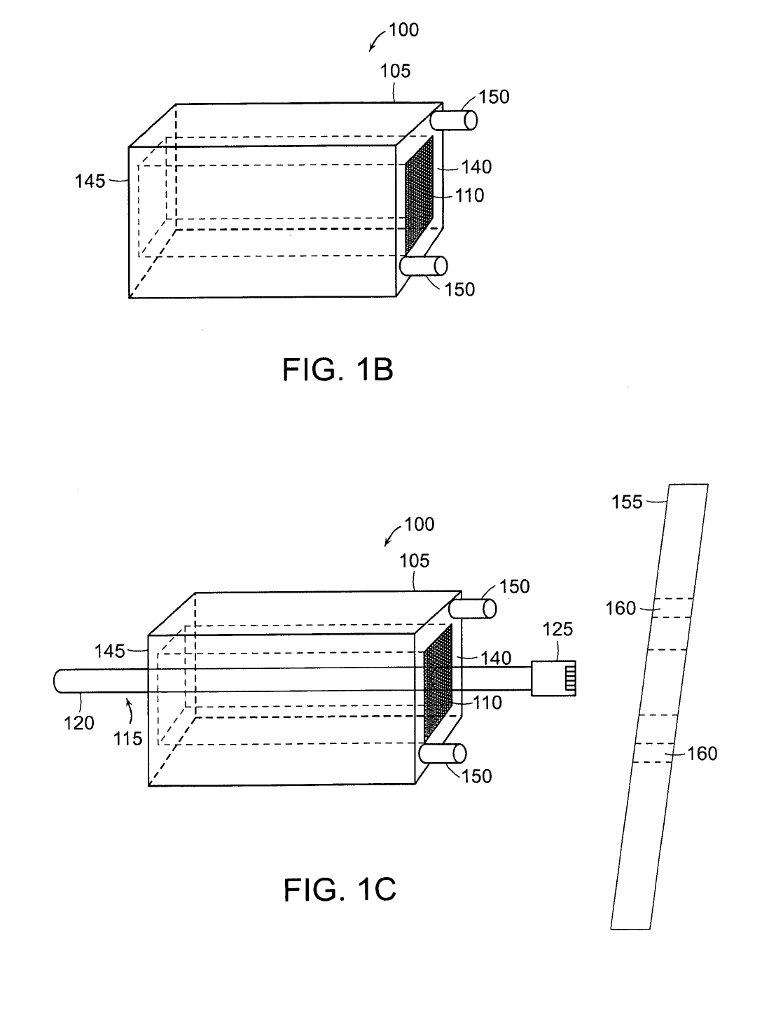

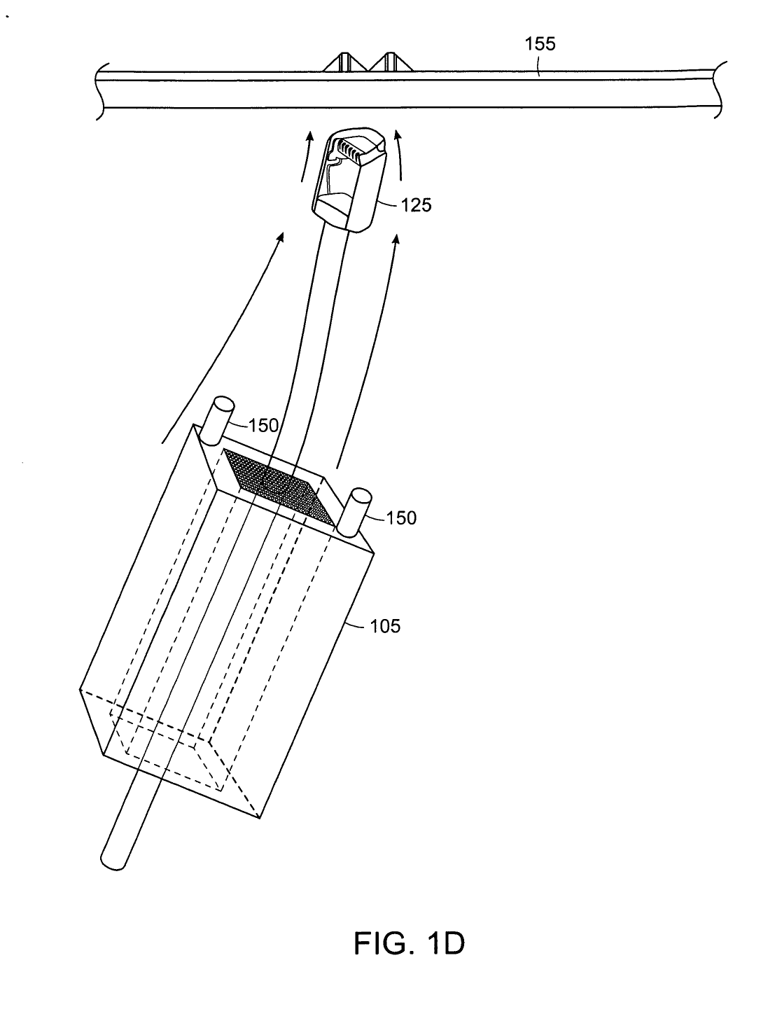

FIG. 1A is a diagram that illustrates a fiber optic cable 115 that includes a fiber portion 120 and a connector portion 125. During assembly, an assembler's hand 110 may pull the fiber portion 120 in an angular direction 127, which may put stress not only on the cable portion 115 but also on the connector portion 125. To relieve strain from the connector 125, a connector cover strain relief (“connector cover”) 100 reduces or minimizes stress to a vulnerable connection point (e.g., where the connector portion 125 meets a faceplate 135 may be employed). Absent the connector cover 100, stress fracture 130, for example, may occur at the connector portion 125 and/or the connector portion 125 may disengage from a faceplate 135 of a chassis. Therefore, it is advantageous to use the connector cover 100 to provide extra support on the connector portion 125 to protect the connector portion 125 against the assembler's hand 110 moving the fiber optic cable 115 during installation of the connector portion 125 to the faceplate 135.

In one embodiment, the connector cover 100 includes a connector/cable strain relief 102 that enables the fiber optic cable 115 to bend a connector/cable junction 122 with a radius of curvature greater than a minimum specified bend radius of the cable while simultaneously supporting the connector portion 125. Extending the connector cover 100 to support the connector/cable junction 122 also aids in relieving stress that would otherwise be imposed on the connector portion 125 and the fiber portion 120 as the fiber portion 120 exits the connector cover 100 by providing a zone where the fiber portion 120 can transition out of the connector cover 100. In other words, without the connector cover 100, the fiber optic cable 115 can bend at nearly a 90 degree angle at the connector/cable junction 122, which in most cases would exceed the minimum bend radius of the cable and damage optical fibers therein and likely the connector portion 120 itself.

A connector cover includes a housing member defining an aperture spanning transversely from a first end to a second end. The aperture may engage a connector therewithin. The cover further includes at least two prongs protruding from the first end in a direction opposite to the second end in an axial direction relative to the aperture. The at least two prongs may be inserted into a panel defining at least two openings to receive the at least two prongs. The at least two prongs in combination with the housing member provide strain relief to the connector in an angular direction relative to the at least two prongs. The at least two prongs may be shaped to self-secure the connector cover to the panel (e.g., a faceplate of a chassis). The at least two prongs may have a cross section that are substantially cylindrical, rectangular, or combination thereof.

The housing member maybe fixedly connected to the connector and may include a side wall extending transversely from a first end to a second end of the housing member. The side wall including at least one peg protruding from the side wall and extending away from the aperture with a length to be connected to at least one respective opening in a structural member positioned alongside the side wall. The at least one peg may secure the connector cover to the structural member to provide strain relief to the connector in an axial direction relative to the at least two prongs. The aperture of the connector cover has dimensions that are expandable and configurable to engage a simplex or duplex fiber optic connector. Moreover, the connector cover may receive within its aperture a Subscriber Connector (SC), Straight Tip (ST), Ferrule Connector (FC), Lucent® Connector (LC), Mechanical Transfer Registered Jack (MT-RJ), Enterprise Systems Connection (ESCON), Fiber Distributed Data Interface (FDDI), or Mechanical Transfer (MT) connector.

The connector cover may further include at least one locking element to self-attach to least two prongs on an opposite side of the panel from a side through which the least two prongs insert into at least two openings.

FIG. 1B is a perspective view of the example connector cover 100 in accordance with an embodiment of the present invention. The connector cover 100 in this embodiment is a single piece that includes a housing member 105 defining an aperture 110 spanning transversely from a first end 140 to a second end 145. The aperture 110 may engage a connector therewithin. The connector cover 100 may further include at least two prongs 150 protruding from the first end 140 in a direction opposite to the second end 145 in an axial direction relative to the aperture 110 and may be inserted into a panel (FIG. 1C, 155) defining at least two openings (FIG. 1C, 160) to receive the at least two prongs 150. The at least two prongs 150 in combination with the housing member 105 may provide strain relief to the connector portion 125 in an angular direction 125 relative to the at least two prongs 150.

It should be understood that the connector cover 100 may be constructed from two or more pieces, such as in an attached clam shell design or independent snap fit design.

FIG. 1C is a three-dimensional view of an example connector cover 100 with a fiber optic cable 115 engaging a panel 155 in accordance with an embodiment of the present invention. The panel 155 may be a faceplate of an Optical Network Terminal (ONT) as described in U.S. patent application Ser. No. 12/154,227 entitled, “Network Terminal Cover,” filed May 21, 2008.

The aperture 110 of the connector cover 100 may engage different types of connectors, including a Subscriber Connector (SC), Straight Tip (ST) connector, Ferrule Connector (FC), Lucent® Connector (LC), Mechanical Transfer Registered Jack (MT-RJ), Enterprise Systems Connection (ESCON), Fiber Distributed Data Interface (FDDI), or Mechanical Transfer (MT) connector. These different types of connectors are used in various applications based upon their unique performance and overall characteristics. The aperture 110 of the connector cover may also have dimensions that are expandable to engage a simplex or duplex fiber optic connector.

FIG. 1D is another three-dimensional view of an example connector cover 100 with a connector portion 125 engaging a faceplate 155 in accordance with an embodiment of the present invention. The at least two prongs 150 may have a cross section that are substantially cylindrical, rectangular, combination thereof, or other geometric shape.

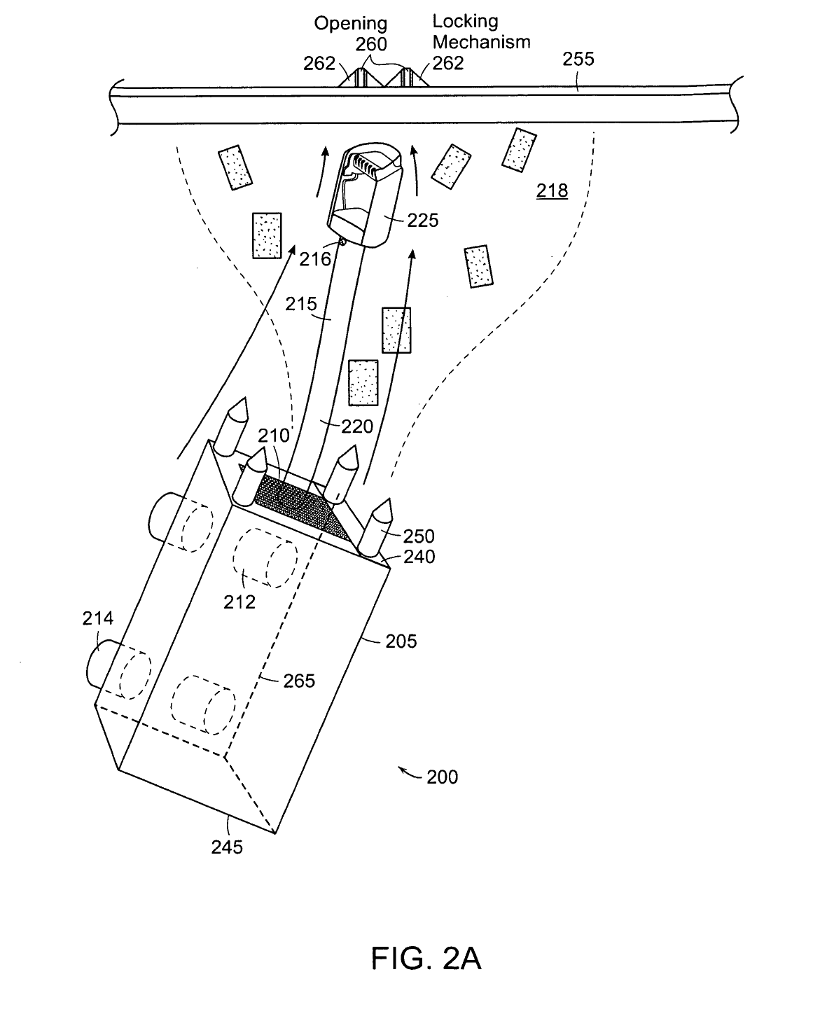

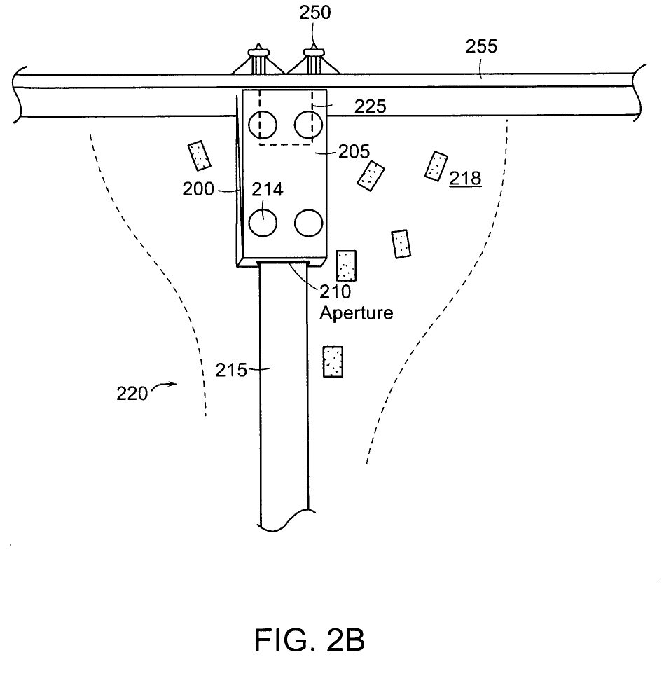

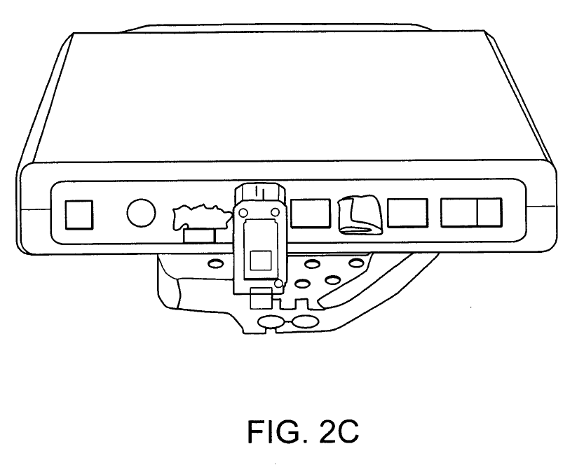

FIG. 2A is an exploded view of another example connector cover 200 with a fiber optic cable 215 engaging a panel 255 in accordance with an embodiment of the present invention. The connector cover 200 is similar to connector cover 100 of FIG. 1A with the exception of a few additional features. The connector cover 200 of FIG. 2A may include a housing member 205 that is fixedly connected to the connector cover 200. The housing member 205 may include a side wall 212 extending transversely from a first end 240 to a second end 245. The side wall 212 may include at least one peg 214 protruding from the side wall 212 and extending away from an aperture 210 with a length to be connected to at least one respective opening 216 in a structural member 218 positioned alongside the side wall 212. The at least one peg 214 may secure the connector cover 200 to the structural member 218 to provide strain relief to the connector portion 225 in an axial direction relative to the at least two prongs 250.

The at least two prongs 250 may be shaped to self-secure the connector cover 200 to the panel 255. The connector cover 200 may include at least one locking element 262 to self-attach to the least two prongs 250 on an opposite side of the panel 255 from a side through which the least two prongs 250 insert into the at least two openings 260. The locking elements retain the connector cover 200 to the panel 255. The locking mechanism 262 may be press fit washers, as illustrated, or a substantially elongated bar (not shown) as part of the panel 255 that engages into a cut out of the free ends of the at least two prongs 250. In another example, the free ends of the at least two prongs 250 may have hooks (not shown) bent inwardly at a right angle as the hooks pass through the at least two openings 260 and which can be resiliently deformed by being deflected outwardly. The locking mechanism, e.g., elongated bar, hooked pegs, barbed pegs, pre-drilled holes in the pegs, etc., are intended for illustrative purposes only, these locking mechanism features may be substituted with any one of a number of functionally equivalent locking mechanism features known in the art or subsequently developed.

FIGS. 2B and 2C are plan views of the connector cover 200 illustrating an operation thereof in accordance with an embodiment of the present invention. The connector cover 200 is attached to the panel 255 and structural member 218 by the at least two prongs 250 and at least one peg 214. If a technician/operator pulls on the fiber portion 220 of the fiber optic cable 215 in an angular direction relative to the at least two prongs 250, the housing member 205 in combination with the at least two prongs 250 may provide strain relief and extra support to the connector portion 225 and fiber portion 220. Further, as optical transmission apparatuses have become popularized, unskilled operators often participate in the maintenance of such apparatuses, which results in an increasing possibility of the fiber optic cable 215 being pulled or tucked to the left or right relative to the at two prongs 250. As a result, the connector cover 200 minimizes stress to the vulnerable connection point (e.g., where the connector portion 225 meets the panel 255). Further, the connector cover 200 may prevent the connector portion 225 from separating from the panel 255.

In another example, if the technician/operator pulls on the fiber portion 220 of the fiber optic cable 215 in an axial direction relative to the at least two prongs 250, the at least one peg 214 may provide strain relief to the connector cover 200 and secure the connector cover 200 to the structural member 218. The structural member 218 may be a bracket as further explained in U.S. patent application Ser. No. 12/154,227 entitled, “Network Terminal Cover,” filed May 21, 2008.

In order for the connector cover 200 to enclose the fiber optic cable 215, the aperture 210 of the connector cover 200 may have dimensions that are larger than the connector portion 225, thereby the connector portion 225 may easily be inserted into the aperture 210. In another embodiment, the connector cover 200 may split open along an inseam 265 similar to a clamp shell to receive the fiber optic cable 215.

The single one piece connector cover 200 can be made of a variety of material to provide strength, flexure, rigidity, and toughness. A single, one piece, connector cover 200 may have certain manufacturing and integration advantages over multi-piece designs because the one-piece design is especially economical to fabricate, minimizes finishing procedures, and can be easily installed.

In another embodiment, the connector cover may include a grommet (not shown), which lines a surface of the aperture 210. The grommet can evenly grip the connector portion 225. The grommet can be made of an elastomeric material and exert a cushioned gripping force against the connector portion 225.

FIG. 3 is an example flow diagram 300 performed in accordance with an example embodiment of the present invention. After the flow diagram 300 starts (305), an operator/technician engages a connector with an aperture defined by a connector cover (310). Next, the technician may insert at least two prongs, protruding from a face of the connector cover, into respective openings defined by a panel (315). If the technician pulls on the fiber optic cable, the connector cover in response may apply respective lateral retraction retention force to the least two prongs to provide strain relief to the connector in an angular direction relative to the at least two prongs (320) the flow diagram 300 then ends (325).

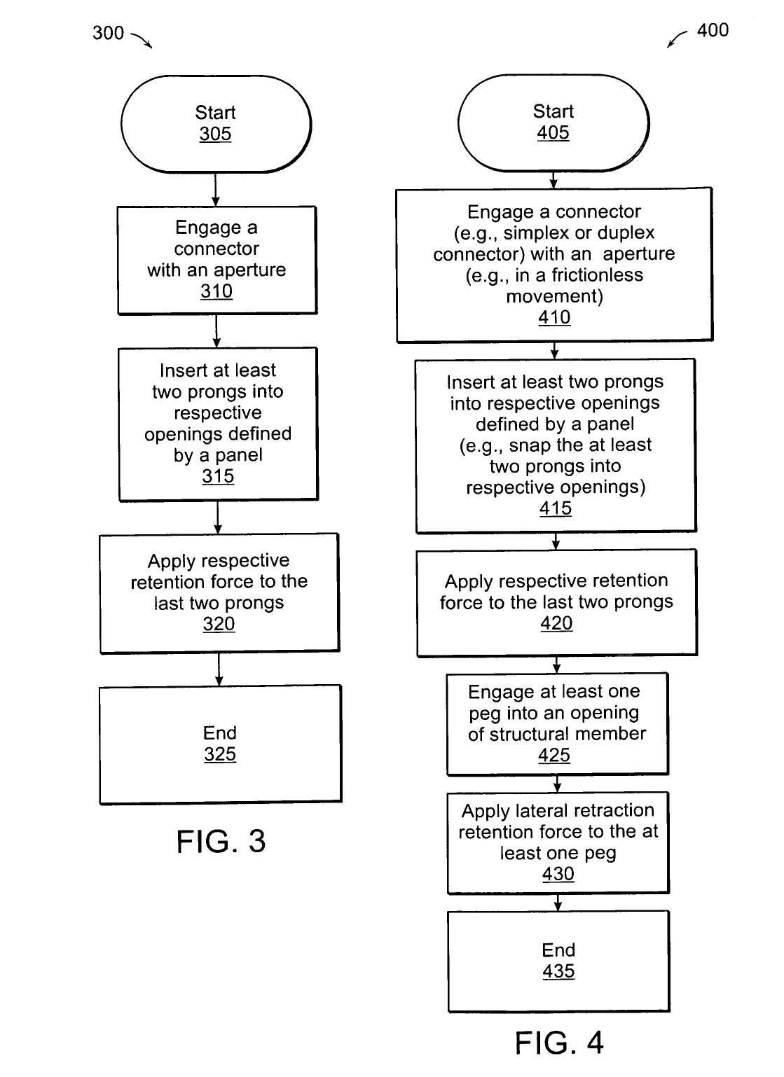

FIG. 4 is another example flow diagram 400 performed in accordance with an example embodiment of the present invention. After the flow diagram 400 starts (405), an operator/technician engages a connector with an aperture defined by a connector cover (410). The aperture of the connector cover may engage a simplex or duplex fiber optic connector. Moreover, the aperture may have dimensions that are larger than the connector portion, thereby inserting the connector through the aperture is done in a substantially frictionless way.

Next, the technician may insert at least two prongs, protruding from a face of the connector cover, into respective openings defined by a panel (415). For example, the technician may snap the at least two prongs each with an outwardly directed peripheral rim-locking grooves to secure the connector cover to the panel. Therefore, if the technician pulls on the fiber optic cable, the connector cover in response may apply respective lateral retraction retention force to the least two prongs to provide strain relief to the connector in an angular direction relative to the at least two prongs (420). The technician may then engage at least one peg protruding from a side wall of the connector cover into an opening of structural member (425). Again, if the technician pulls on the fiber optic cable, the connector cover may also respond by applying lateral retraction retention force to the at least one peg (430) to secure the connector cover to the structural member (430). The flow diagram (400) then ends (435).

While this invention has been particularly shown and described with references to example embodiments thereof, it will be understood by those skilled in the art that various changes in form and details may be made therein without departing from the scope of the invention encompassed by the appended claims.

It should be understood that the flow diagrams of FIGS. 3 and 4 are merely examples, and other configurations, arrangements, additional blocks, fewer blocks, and so forth are possible in other embodiments.

It should be further understood that the connector cover can provide strain relief not only to a fiber optic connector, but also to a more conventional metal wire connector (e.g., copper) or other technology connectors, such as Radio Frequency (RF), RJ (Registered Jack) type jacks for receiving mating modular plugs (e.g., RJ-11 and RJ-45), and mechanical connectors.

What is claimed is:

1. A connector cover, comprising:
a housing member defining an aperture spanning transversely from a first end to a second end, the aperture configured to engage a connector therewithin; and
at least two prongs protruding from the first end in a direction opposite to the second end in an axial direction relative to the aperture and configured to be inserted into a panel defining at least two openings configured to receive the at least two prongs, the at least two prongs in combination with the housing member configured to provide strain relief to the connector in an angular direction relative to the at least two prongs.

2. The connector cover of claim 1 wherein the housing member is fixedly coupled to the connector and wherein the housing member includes a side wall extending transversely from the first end to the second end, the side wall including at least one peg protruding from the side wall and extending away from the aperture with a length configured to be coupled to at least one respective opening in a structural member positioned alongside the side wall, the at least one peg configured to secure the connector cover to the structural member to provide strain relief to the connector in an axial direction relative to the at least two prongs.

3. The connector cover of claim 1 wherein the aperture has dimensions that are expandable and configurable to engage a simplex or duplex fiber optic connector.

4. The connector cover of claim 1 wherein the connector cover is configured to receive within its aperture a Subscriber Connector (SC), Straight Tip (ST), Ferrule Connector (FC), Lucent® Connector (LC), Mechanical Transfer Registered Jack (MT-RJ), Enterprise Systems Connection (ESCON), Fiber Distributed Data Interface (FDDI), or Mechanical Transfer (MT) connector.

5. The connector cover of claim 1 wherein the at least two prongs are shaped to self-secure the connector cover to the panel.

6. The connector cover of claim 1 further including at least one locking element configured to self-attach to the least two prongs on an opposite side of the panel from a side through which the least two prongs insert into the at least two openings.

7. The connector cover of claim 1 wherein the panel is a faceplate of a chassis.

8. The connector cover of claim 1 wherein the at least two prongs have a cross section that are substantially cylindrical, rectangular, or combination thereof.

9. A method for providing strain relief to a connector, comprising:
engaging the connector with an aperture defined by a connector cover;
inserting at least two prongs, protruding from a face of the connector cover, into respective openings defined by a panel; and
applying respective lateral retraction retention force to the least two prongs to provide strain relief to the connector in an angular direction relative to the at least two prongs.

10. The method of claim 9 further including:
engaging at least one peg protruding from a side wall of the connector cover into an opening of a structural member; and
applying lateral retraction retention force to the at least one peg to secure the connector cover to the structural member.

11. The method of claim 9 wherein engaging the connector into the aperture of the connector cover by inserting the connector through the aperture in a substantially frictionless movement.

12. The method of claim 9 wherein engaging the connector into the aperture of the connector cover is engaging a simplex or duplex fiber optic connector.

13. The method of claim 9 wherein engaging the connector into the aperture of the connector cover is engaging a Subscriber Connector (SC), Straight Tip (ST), Ferrule Connector (FC), Lucent® Connector (LC), Mechanical Transfer Registered Jack (MT-RJ), Enterprise Systems Connection (ESCON), Fiber Distributed Data Interface (FDDI), or Mechanical Transfer (MT) connector.

14. The method of claim 9 further including snapping the at least two prongs each with an outwardly directed peripheral rim-locking grooves to secure the connector cover to the panel.

15. A connector cover to provide strain relief to a connector, comprising:
means for covering a connector cover; and
means for coupling the means for covering the connector to a panel in an axial direction of the connector to provide strain relief to the connector in an angular direction.

16. The connector cover of claim 15 further including means for securing the connector cover to a structural member in a longitudinal and lateral directions relative to the connector.

17. The connector cover of claim 15 wherein means for covering the connector cover includes means for covering the connector cover in a substantially frictionless movement.

18. The connector cover of claim 15 wherein means for covering the connector includes means for engaging a simplex or duplex fiber optic connector.

19. The connector cover of claim 15 wherein means for covering the connector includes means for engaging a Subscriber Connector (SC), Straight Tip (ST), Ferrule Connector (FC), Lucent® Connector (LC), Mechanical Transfer Registered Jack (MT-RJ), Enterprise Systems Connection (ESCON), Fiber Distributed Data Interface (FDDI), or Mechanical Transfer (MT) connector.

20. The connector cover of claim 15 further including means for engaging at least one peg of the connector cover into an opening of a structural member to secure the connector cover to the structural member.
